(19) United States
(12) Patent Application Publication
(10) Pub. No.: US 2004/0141701 A1
(43) Pub. Date: Jul. 22, 2004

(54) Dispersion compensation module and optical transmission system

(75) Inventors: Takeshi Yagi, Tokyo (JP); Jun Terada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd., Tokyo (JP)

(21) Appl. No.: 10/627,730

(22) Filed: Jul. 28, 2003

Related U.S. Application Data
(60) Provisional application No. 60/398,569, filed on Jul. 26, 2002.

(30) Foreign Application Priority Data
Sep. 9, 2002 (JP) 2002-263227
Jun. 9, 2003 (JP) 2003-164285

(51) Int. Cl. G02B 6/02; G02B 6/255

(52) U.S. Cl. 385/123; 385/99

(57) ABSTRACT

A first dispersion compensation fiber and a second dispersion compensation fiber are serially connected to constitute a dispersion compensation module, the first dispersion compensation fiber having a negative dispersion value and a negative dispersion slope, and the second dispersion compensation fiber having a negative dispersion value and a negative dispersion slope different from the negative dispersion value and the negative dispersion slope that the first dispersion compensation fiber has. The dispersion slope that first dispersion compensation fiber presents a change convex to the upward direction following a wavelength change. The dispersion slope that the second dispersion compensation fiber presents a change convex to the downward direction following a wavelength change. The transmission optical fiber is connected to the dispersion compensation module. When a WDM transmission is carried out in an optionally selected signal waveband including at least 1530 to 1625 nanometers, the dispersion compensation module securely compensates for the dispersion and the dispersion slope accumulated in the transmission optical fiber.

### BACKGROUND OF THE INVENTION

1) Field of the Invention

The present invention relates to a dispersion-compensating module and an optical transmission system using the same.

2) Description of the Related Art

Dispersion-compensating modules are used to compensate for the dispersion and the dispersion slope cumulated in a transmission line for a wavelength division multiplexing (hereinafter, “WDM”) transmission. These modules are configured with one kind of dispersion-compensating optical fiber having optimum dispersion-compensating characteristics for a specific signal wavelength band. The wavelength band may be C-band (1530 to 1565 nanometers), L-band (1565 to 1625 nanometers), or S-band (1460 to 1530 nanometers).

As an example, a module used for compensating an optical fiber that is optimized for a low dispersion operation in a wavelength range from 1290 to 1330 nanometers is configured with one kind of optical fiber having dispersion of −65.5 ps/nm/km at a wavelength of 1550 nanometers (see Patent Literature 1).

Patent Literature 1:

Japanese Patent Application Laid-open Publication No. H6-11620).

The WDM transmission is becoming increasingly high-speed with the advent of technology. However, there is a problem with the conventional modules in that variance of the cumulative dispersion in the transmission line sometimes exceeds the dispersion tolerance, which is a permissible range of a cumulative dispersion in the high-speed WDM transmission line, as the transmission speed increases. If the variance exceeds the dispersion tolerance, the optical waveform distorts, which leads to the occurrence of a malfunction due to an inter symbol interference. The variance of the cumulative dispersion further limits the increase in the WDM transmission speed.

Moreover, when plural wavelength bands, for example, the C-band and the L-band, are used together, a module configured with one kind of optical fiber can not solve the purpose. In such cases, first the signal light is separated into signals of each wavelength band, and each signal is compensated individually passed through a separate optical fiber to perform the compensation However, this configuration makes the optical transmission system more complicated.

One approach to solve the above-mentioned problem is to use the Raman amplifier as an optical amplifier. When the Raman amplifier is used, signals of both the C-band and the L-band can be simultaneously amplified. However, when the Raman amplifier is used, this advantage is offset by the above-mentioned problem of dispersion compensation in many cases. Consequently, a dispersion-compensating module configured by a dispersion-compensating optical fiber that can simultaneously compensate for the dispersion in the signals of both the C-band and the L-band is strongly desired.

### SUMMARY OF THE INVENTION

It is an object of the present invention to provide a dispersion compensating module that suppresses a variance in a cumulative wavelength dispersion in a transmission line after a dispersion compensating, thereby to realize a dispersion compensating in a high-speed WDM transmission line.

It is another object of the present invention to provide an optical transmission system using a dispersion compensating module that suppresses a variance in a cumulative wavelength dispersion in a transmission line after a dispersion compensating, thereby to realize a dispersion compensating in a high-speed WDM transmission line.

The dispersion compensating module according to the present invention has at least two dispersion compensating fibers to compensate for a dispersion and a dispersion slope accumulated in a transmission optical fiber in a predetermined signal wavelength band. The dispersion compensating module comprises a first dispersion compensating fiber having a negative dispersion value and a negative dispersion slope, a second dispersion compensating fiber having a negative dispersion value and a negative dispersion slope different from the negative dispersion value and the negative dispersion slope that the first dispersion compensating fiber has, and a jointing unit that serially joints between the first dispersion compensating fiber and the second dispersion compensating fiber. The predetermined signal wavelength band is an optional signal wavelength band including at least 1530 to 1625 nanometers. The negative dispersion slope that the first dispersion compensating fiber presents a change convex to the upward direction following a wavelength change, and the negative dispersion slope that the second dispersion compensating fiber presents a change convex to the downward direction following a wavelength change.

According to the present invention, the jointing unit serially joints between the first dispersion compensating fiber and the second dispersion compensating fiber, the first dispersion compensating fiber having a negative dispersion value and a negative dispersion slope, and the second dispersion compensating fiber having a negative dispersion value and a negative dispersion slope different from the negative dispersion value and the negative dispersion slope that the first dispersion compensating fiber has. In an optional signal wavelength band including at least 1530 to 1625 nanometers, the dispersion slope that the first dispersion compensating fiber presents a change convex to the upward direction following a wavelength change, and the dispersion slope that the second dispersion compensating fiber presents a change convex to the downward direction following a wavelength change. Therefore, according to the present invention, it is possible to securely compensate for a cumulative dispersion and a cumulative dispersion slope in the WDM transmission line. Further, a variance in the cumulative wavelength dispersion value in the transmission line after the dispersion compensating can be suppressed. Furthermore, a cumulative dispersion and a cumulative dispersion slope in the WDM transmission of an optional signal wavelength band including at least 1530 to 1625 nanometers can be securely compensated for.

Further, the optical transmission system according to the present invention has at least the dispersion compensating module according to the present invention.

According to the present invention, an optical transmission system suitable for a high-speed WDM transmission can be realized.

### BRIEF DESCRIPTION OF THE DRAWINGS

FIG. 1 illustrates a dispersion-compensating module according to a first embodiment of the present invention;

FIG. 2 is a longitudinal cross-section at a jointed portion between a dispersion-compensating fibers in the dispersion-compensating module according to the first embodiment and a dispersion-compensating module according to a modification of the first embodiment;

FIG. 3 illustrates the dispersion-compensating module according to the modification of the first embodiment;

FIG. 4 is a-graph of wavelength characteristics of dispersion of a transmission optical fiber, and a first dispersion-compensating fiber and a second dispersion-compensating fiber that constitute the dispersion-compensating module according to the first embodiment;

FIG. 5 is a graph of wavelength characteristics of dispersion and the variance in the wavelength characteristics of dispersion of the transmission optical fiber after dispersion compensation is performed using only the first dispersion-compensating fiber that constitutes the dispersion compensating module according to the first embodiment;

FIG. 6 illustrates wavelength characteristics of dispersion and the variance in the wavelength characteristics of dispersion of the transmission optical fiber after dispersion compensation is performed using the dispersion-compensating module according to the first embodiment;

FIG. 7 illustrates a dispersion-compensating module according to a second embodiment of the present invention;

FIG. 8 illustrates wavelength characteristics of dispersion of the dispersion-compensating module according to the second embodiment;

FIG. 9 illustrates wavelength characteristics of cumulative dispersion of the transmission optical fiber after the dispersion is compensated according to the second embodiment;

FIG. 10 illustrates wavelength characteristics of dispersion slope of a dispersion-compensating fiber, the dispersion-compensating module, and the transmission optical fiber according to the second embodiment;

FIG. 11 illustrates a refractive index profile and a cross-section of the dispersion-compensating fiber according to the second embodiment; and

FIG. 12 is a block diagram of an optical transmission system according to a third embodiment of the present invention.

### DETAILED DESCRIPTION

The present invention relates to a dispersion-compensating module that compensates for a dispersion and a dispersion slope cumulated in a wavelength division multiplexing transmission (hereinafter, “WDM transmission”) line by linking the dispersion-compensating module to an optical fiber used as a transmission line of a WDM transmission line, and a optical transmission system using the dispersion-compensating module.

Exemplary embodiments of the dispersion-compensating module and the optical transmission system according to the present invention will be explained in detail below with reference to the accompanying drawings. The present invention is not limited by these embodiments. The S-band, the C-band, and the L-band are band names based on the definition of the optical wavelength band determined by the International Telecommunication Union-Telecommunication Sector (ITU-T).

### FIRST EMBODIMENT

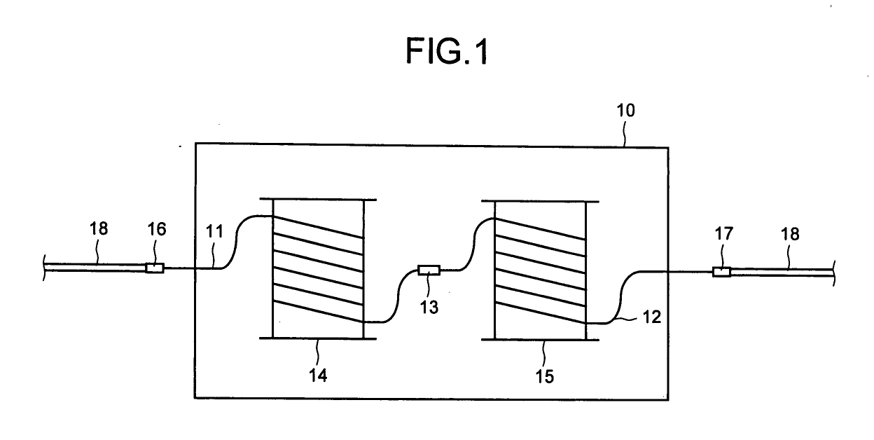

FIG. 1 illustrates a dispersion-compensating fiber 10 according to a first embodiment of the present invention. This dispersion-compensating module 10 includes a dispersion-compensating fiber 11, a dispersion-compensating fiber 12, a bobbin 14, a bobbin 15, and a jointing unit 13 for jointing one of the two ends of the fibers 11 and 12. The other end of the dispersion compensating module 10 is serially linked to a transmission optical fiber 18 via a connector 16, and the other end of the dispersion compensating module 10 is serially linked to the transmission optical fiber 18 via a connector 17.

The dispersion-compensating fiber 11 has a dispersion value D1 [ps/nm/km] and a dispersion slope S1 [ps/nm²/km], and is wound around the bobbin 14.

The dispersion-compensating fiber 12 has a dispersion value D2 [ps/nm/km] and a dispersion slope S2 [ps/nm²/km], and is wound around the bobbin 15. The dispersion value D2 and the dispersion slope S2 of the dispersion-compensating fiber 12 are different from the dispersion value D1 and the dispersion slope S1 of the dispersion-compensating fiber 11 respectively. A relationship of D1/S1 ≦D2/S2 is established for a maximum wavelength of a predetermined signal wavelength band.

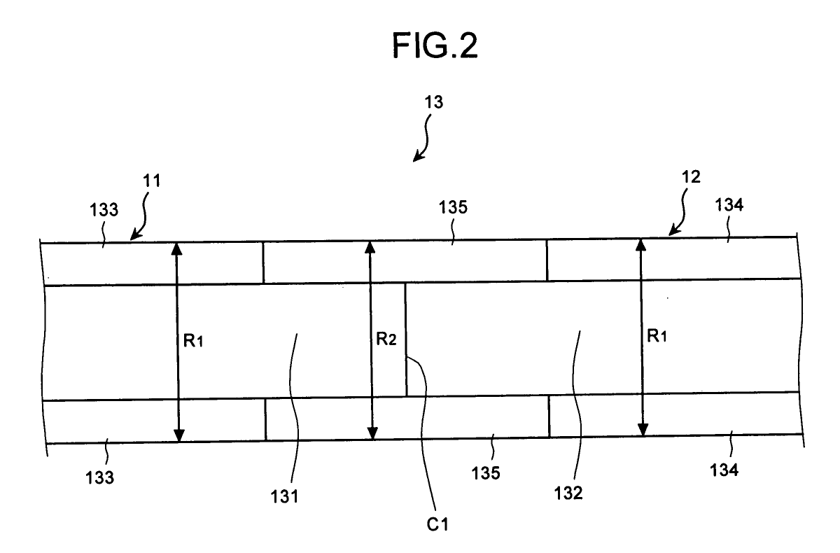

The configuration of the jointing unit having the dispersion compensating fiber 11 and the dispersion compensating fiber 12 serially jointed by fusion will be explained in detail below with reference to FIG. 2. FIG. 2 is a longitudinal cross-section of the jointing unit 13.

In this jointing unit 13, a glass layer 131 of the dispersion-compensating fiber 11 and a glass layer 132 of the dispersion-compensating fiber 12 are directly serially jointed by fusion-splicing at a boundary of a contact surface C1. Portions of the glass layer 131 other than a portion near the contact surface C1 is coated and protected by an ultraviolet cured resin film 133. Similarly, portions of the glass layer 132 other than a portion near the contact surface C1 is coated and protected by an ultraviolet cured resin film 134. An ultraviolet cured resin film 135 coats and protects portions of the glass layers 131 and 132 near the fusion-spliced portion. The films 133 and 134 have a diameter R1 respectively, and the coating film 135 has a diameter R2.

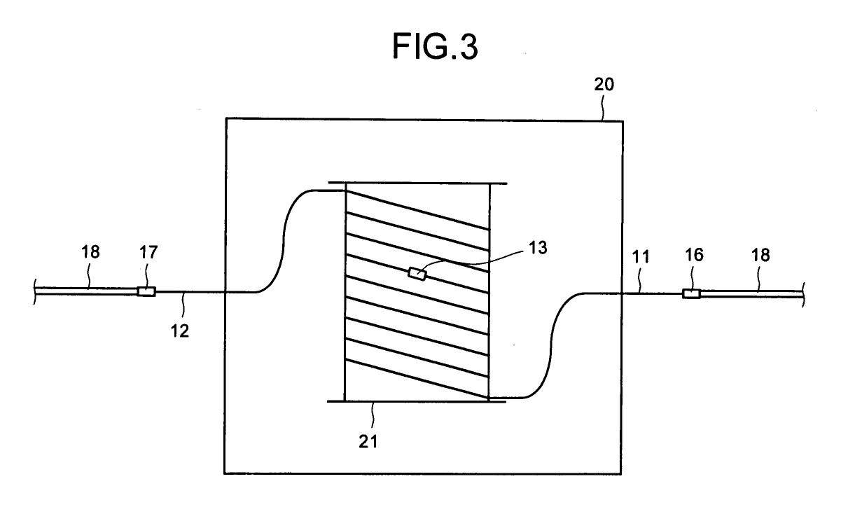

As a modification of the first embodiment, one bobbin may be provided in place of the bobbins 14 and 15. Such a dispersion-compensating module 20 is shown in FIG. 3.

This dispersion-compensating module 20 includes the dispersion-compensating fiber 11, the dispersion-compensating fiber 12, a bobbin 21, and the jointing unit 13 for jointing one of the two ends of the fibers 11 and 12. The other end of the dispersion compensating module 20 is serially linked to the transmission optical fiber 18 via the connector 16, and the other end of the dispersion compensating module 20 is serially linked to the transmission optical fiber 18 via the connector 17.

The dispersion-compensating fibers 11 and 12 are wound around the bobbin 21. At the time of winding the dispersion-compensating fiber 11 and the dispersion-compensating fiber 12, it is preferable that the dispersion-compensating fiber 12 is first wound around the bobbin 21, as a ratio of the dispersion value D2 to the dispersion slope S2 (D2/S2) of the dispersion-compensating fiber 12 is larger than a ratio of the dispersion value D1 to the dispersion slope S1 (D1/S1) of the dispersion-compensating fiber 11. This is because in the maximum wavelength of a predetermined signal wavelength band, a bending loss of the dispersion-compensating fiber 12 is smaller than a bending loss of the dispersion-compensating fiber 11.

Referring back to FIG. 2, it is preferable that the coating films 133, 134, and 135 are made of the same material. It is also preferable that a difference between the diameters R1 and R2 is close to zero.

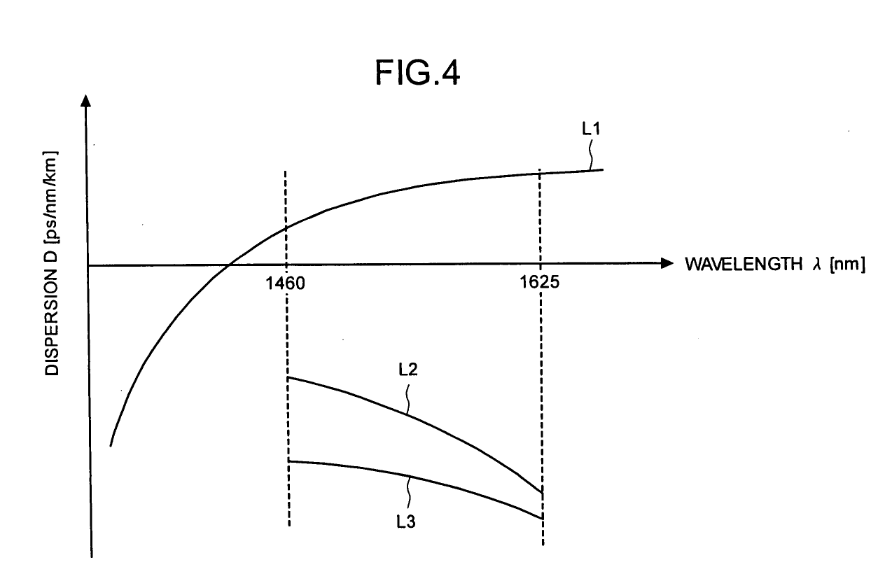

The compensation for the dispersion and the dispersion slope in the dispersion-compensating fiber 18 according to the dispersion-compensating module 10 will be explained in detail below with reference to FIG. 4 to FIG. 6.

FIG. 4 is a graph of wavelength characteristics of dispersion of the transmission optical fiber 18 (curve L1), the dispersion-compensating fiber 11 (curve L2), and the dispersion-compensating fiber 12 (curve L3). The curves L2 and L3 represent only the dispersion in the wavelength band from 1460 to 1625 nanometers.

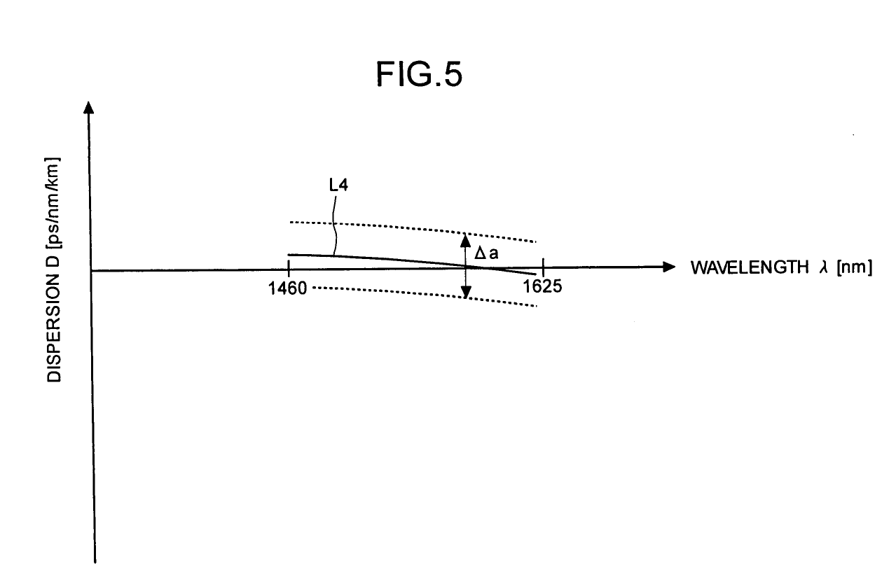

FIG. 5 is a graph of wavelength characteristics of the dispersion of the transmission optical fiber 18 (curve L4) after the dispersion compensation is performed using the dispersion-compensating fiber 11. The correlation curve represents only the wavelength characteristics of the dispersion in the wavelength band from 1460 to 1625 nanometers.

As shown in FIG. 5, the wavelength characteristics of the dispersion has a variance in the range of Δa. In other words, when only the dispersion-compensating fiber 11 is used to compensate for the dispersion and the dispersion slope of the transmission optical fiber 18, the wavelength characteristics of the dispersion after the dispersion compensation has the variance Δa.

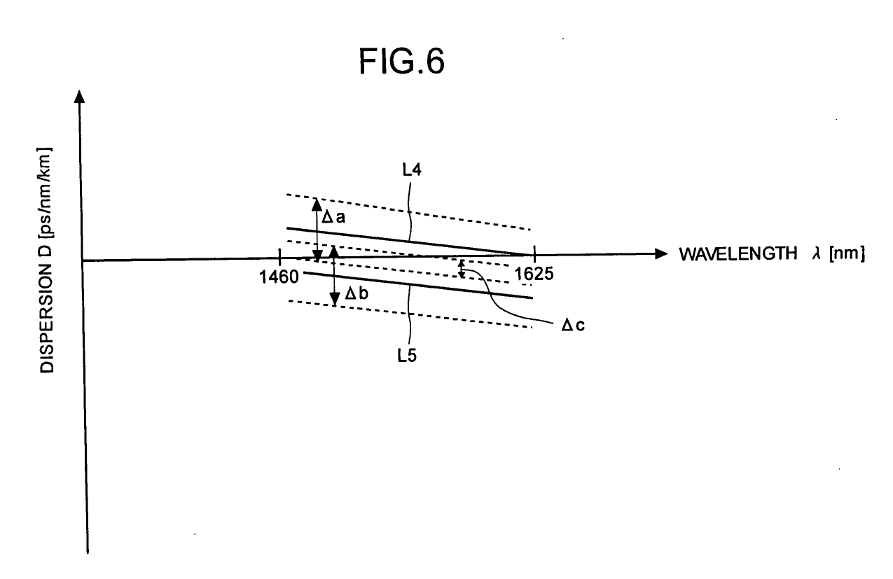

FIG. 6 is a graph of wavelength characteristics of the dispersion of the transmission optical fiber 18 after the dispersion compensation is performed using both the dispersion-compensating fibers 11 (curve L4) and 12 (curve L5).

As shown in FIG. 6, the wavelength characteristics of the dispersion have a variance in the range of Δb for the dispersion-compensating fiber 12. In other words, when only the dispersion-compensating fiber 12 is used to compensate for the dispersion and the dispersion slope of the transmission optical fiber 18, the wavelength characteristics of the dispersion after the dispersion compensation has the variance Δb.

When the dispersion-compensating module 10 is used to compensate for the dispersion and the dispersion slope of the transmission optical fiber 18, the correlation curve representing the wavelength characteristics of the dispersion of the transmission optical fiber 18 after the dispersion compensation has a variance as a superimposed portion between the variance Δa of the curve L4 and the variance Δb of the curve L5. In other words, the wavelength characteristics of the dispersion of the transmission optical fiber 18 after the dispersion compensation according to the dispersion-compensating module 10 has a variance Δc.

Among the variances Δa to Δc, the variance Δa and the variance Δb are in an approximation relationship. The variance Δc is smaller than the variance Δa or the variance Δb. In other words, the dispersion compensation can be performed more effectively when the dispersion-compensating module 10 is configured with the dispersion-compensating fibers 11 and 12 than when it is configured with either of the dispersion-compensating fiber 11 and the dispersion-compensating fiber 12.

Same effect can be obtained in the dispersion-compensating module 20.

Experiments were performed using the dispersion-compensating module 20 in the C-band (1530 to 1565 nanometers). The results of these experiments will be explained in detail below.

In these experiments, the transmission optical fiber 18 having the dispersion value D0 of 5.0 ps/nm/km and the dispersion slope S0 of 0.045 ps/nm²/km, in the wavelength of 1550 nanometers were employed. The transmission optical fiber 18 had a length of 80.0 kilometers. The total dispersion value and the total dispersion slope of the transmission optical fiber 18 were 400 ps/nm and 3.6 ps/nm² respectively. The ratio of the dispersion value D0 to the dispersion slope S0, i.e., D0/S0, was 111.1.

The dispersion-compensating fiber 11 having the dispersion value D1 of −95.0 ps/nm/km and the dispersion slope S1 of −1.00 ps/nm²/km, in the wavelength of 1550 nanometers was employed. The dispersion-compensating fiber 11 had a length of 3.6 kilometers. The total dispersion value and the total dispersion slope of the dispersion-compensating fiber 11 were −342 ps/nm and −3.6 ps/nm² respectively. The ratio of the dispersion value D1 to the dispersion slope S1, i.e., D1/S1, was 95.0.

The dispersion-compensating fiber 12 having the dispersion value D2 of 120 ps/nm/km and the dispersion slope S2 of −0.90 ps/nm²/km, in the wavelength of 1550 nanometers was employed. The dispersion-compensating fiber 12 had a length of 0.6 kilometer. The total dispersion value and the total dispersion slope of the dispersion-compensating fiber 12 were −72 ps/nm and −0.5 ps/nm² respectively. The ratio of the dispersion value D2 to the dispersion slope S2, i.e., D2/S2, was 133.3.

Table 1 also shows the characteristics of the transmission optical fiber 18 and the dispersion-compensating fibers 11 and 12 respectively, and the characteristics of the dispersion-compensating fibers 11 and 12 in a state that these fibers are jointed in series.

TABLE 1

| | | | | | Total |
|---|---|---|---|---|---|
| | | | Dispersion | Total | dispersion |
| | Length | Dispersion | slope | dispersion | slope |
| | [km] | [ps/nm/km] | [ps/nm²/km] | [ps/nm] | [ps/nm²] |
| Fiber 11 | 3.6 | −95 | −1.0 | −342 | −3.6 |
| Fiber 12 | 0.6 | −120 | −0.90 | −72 | −0.54 |
| Module 10 | 4.2 | −98.6 | −0.986 | −414 | −4.14 |
| Fiber 18 | 80 | 5.0 | 0.045 | 400 | 3.6 |
| Result | 80 | −0.175 | −0.00675 | −14 | −0.54 |

As the dispersion-compensating fibers 11 and 12 are installed in a local station as a module, these dispersion-compensating fibers do not contribute as a transmission line. Therefore, in calculating the total dispersion value and the total dispersion slope, the lengths of the dispersion-compensating fibers 11 and 12 are not taken into account as a transmission line length.

As can be seen from the lowest column of Table 1, the dispersion and the dispersion slope of the compensated transmission optical fiber 18 were suppressed to −0.175 ps/nm/km and −0.00675 ps/nm²/km, respectively.

In these experiment, the ratio D0/S0 of the transmission optical fiber 18, the ratio D1/D1 of the dispersion-compensating fiber 11, and the ratio D2/D2 of the dispersion-compensating fiber 12 satisfies the inequalities 0.8×(D0/S0)≦D1/S1<D0/S0 and D0/S0<D2/S2≦1.2×(D0/S0). In other words, the combination of the dispersion-compensating fibers 11 and 12 is suitable for compensating the dispersion of the transmission optical fiber 18.

Furthermore, in the dispersion-compensating module 20, a dispersion value Dt [ps/nm/km] and a dispersion slope St [ps/nm²/km] satisfy the inequalities Dt≦−20 and 0.9×(D0/S0)≦Dt/St≦1.1×(D0/S0).

Out of the dispersion-compensating fibers 11 and 12, it is preferable that the dispersion-compensating fiber 12, which has a smaller bending loss in the wavelength of 1565 nanometers, is first wound around the bobbin 21. This is to reduce the bending loss.

The transmission optical fiber 18 may be a 1.3 micrometer zero dispersion single mode fiber, a 1.5 micrometer zero dispersion shifted single mode fiber, or a 1.5 micrometer non-zero dispersion single mode fiber.

Thus, in the dispersion-compensating module 10, the dispersion-compensating fibers 11 and 12 having the dispersion and the dispersion slope optimized for the transmission optical fiber 18 are serially jointed by fusion-splicing. As a result, the dispersion-compensating module 10 can securely compensate for the dispersion and the dispersion slope cumulated in the WDM transmission line in the total signal wavelength band of 1460 to 1625 nanometers over the S-band, the C-band, and the L-band. Further, the dispersion-compensating module 10 can suppress the variance in the cumulative dispersion in the transmission line after the compensation.

In other words, when the optical fiber in which the dispersion is compensated for by the dispersion-compensating module 10 is used as a transmission line, a high-speed WDM transmission can be realized in high quality.

Similarly, in the dispersion-compensating module 20, which is the modification of the dispersion-compensating module 10, the dispersion-compensating fibers 11 and 12 having the dispersion and the dispersion slope optimized for the transmission optical fiber 18 are serially jointed by fusion-splicing. As a result, the dispersion-compensating module 20 can realize the high performance of the dispersion compensation. Moreover, the dispersion-compensating module 20 is smaller and more compact than the dispersion-compensating module 10 as only one bobbin 21 is used to wind the dispersion-compensating fiber 11 and 12.

Moreover, the dispersion-compensating fiber 12, having a smaller bending loss in a maximum wavelength of a predetermined signal wavelength band is first wound around the bobbin 21. Therefore, the bending loss increase can be suppressed.

The present invention can be applied to a dispersion-compensating module having an optimum dispersion-compensating capacity for the WDM transmission optical fiber using the S-band or the L-band, in the-same manner as the C-band.

### SECOND EMBODIMENT

According to the first embodiment, the two kinds of dispersion-compensating fibers having the dispersion values and the dispersion slopes that are optimized for the transmission optical fiber are serially jointed by fusion-splicing. The dispersion-compensating module compensates for the dispersion and the dispersion slope cumulated in the transmission optical fiber, and suppresses the variance in the cumulative dispersion after the compensation. On the other hand, according to a second embodiment of the present invention, two kinds of dispersion-compensating fibers having different wavelength characteristics of dispersion are serially jointed by fusion-splicing at a predetermined length ratio. The cumulative dispersion after compensation in the transmission optical fiber for a WDM transmission in the wavelength range from 1530 to 1625 nanometers is limited to a range from −0.3 to 0.3 ps/nm/km. The transmission optical fiber 18 is optimized for a low dispersion operation in the wavelength range from 1290 to 1330 nanometers.

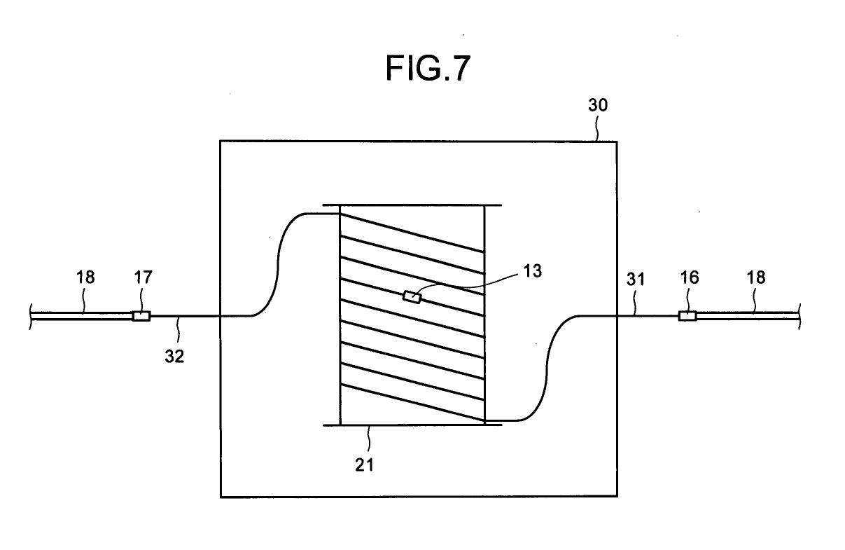

FIG. 7 is a schematic view of a configuration of a dispersion-compensating module 30 according to the second embodiment of the present invention. A bobbin around which dispersion-compensating fibers are wound, a jointing unit for linking between the fibers, and a transmission optical fiber have functions similar to those of the corresponding sections of the dispersion-compensating module 20 shown in FIG. 3. Therefore, reference numerals identical to those in FIG. 3 are attached to these sections.

A dispersion-compensating fiber 31 having a dispersion value D3 and a dispersion slope S3 and a dispersion-compensating fiber 32 having a dispersion value D4 and a dispersion slope S4 are serially jointed by fusion-splicing via the jointing unit 13. Thereafter, these dispersion-compensating fibers 31 and 32 are wound around the bobbin 21. The dispersion-compensating fiber 32 is serially linked to the transmission optical fiber 18 via the connector 17. The optical fiber 31 is serially linked to the transmission optical fiber 18 via the connector 16.

In a maximum wavelength of a predetermined signal wavelength band, the bending loss of the dispersion-compensating fiber 32 is smaller than the bending loss of the dispersion-compensating fiber 31. In other words, a ratio of the dispersion value D4 to the dispersion slope S4, i.e., D4/S4, is larger than a ratio of the dispersion value D3 to the dispersion slope S3, i.e., D3/S3. In this case, out of the dispersion-compensating fibers 31 and 32, it is preferable that the dispersion-compensating fiber 32 is first wound around the bobbin 21.

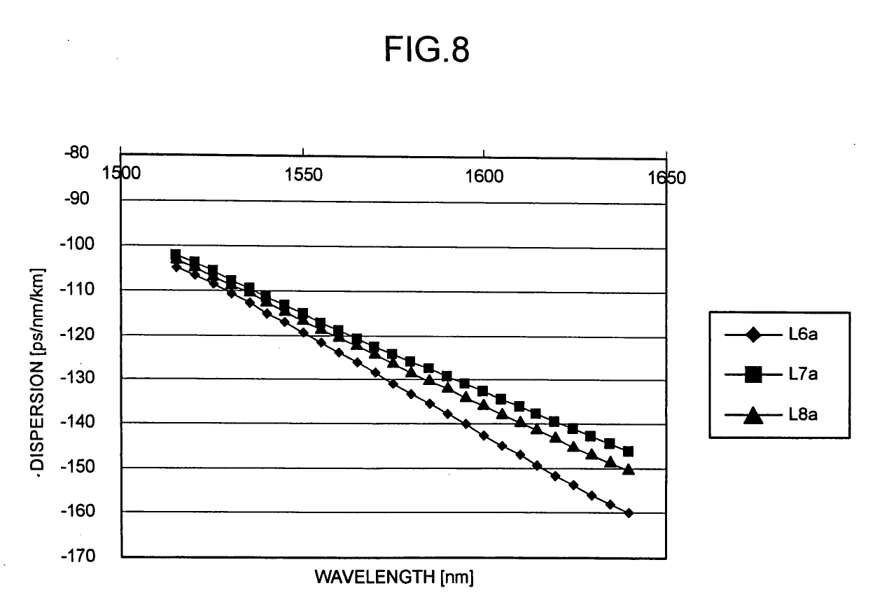

The compensation for the dispersion and the dispersion slope in the transmission optical fiber 18 according to the dispersion-compensating module 30 will be explained in detail based on an exemplification of detailed values. FIG. 8 is a graph of wavelength characteristics of dispersion of the dispersion-compensating fiber 31 (curve L6a), the dispersion-compensating fiber 32 (curve L7a), and the dispersion-compensating module 30 (curve L8a) respectively in the wavelength range from 1530 to 1625 nanometers.

As can be seen from FIG. 8, the dispersion-compensating fiber 31 and the dispersion-compensating fiber 32 have the dispersion value D3 and the dispersion value D4 that are always equal to or less than −100 ps/nm/km in the wavelength range from 1530 to 1625 nanometers. When the dispersion values are compared in an optional wavelength within the wavelength range from 1530 to 1625 nanometers, the dispersion value D3 is always lower than the dispersion value D4.

When the dispersion-compensating module 30 has a configuration that the dispersion-compensating fiber 31 and the dispersion-compensating fiber 32 are serially jointed at an adjusted length ratio of 3:7, the dispersion-compensating module 30 always has the dispersion value Dt of equal to or less than −100 ps/nm/km in the wavelength range from 1530 to 1625 nanometers. This dispersion value Dt presents a value equal to or larger than the dispersion value D3 and equal to or smaller than the dispersion value D4 in an optional wavelength within the wavelength range from 1530 to 1625 nanometers.

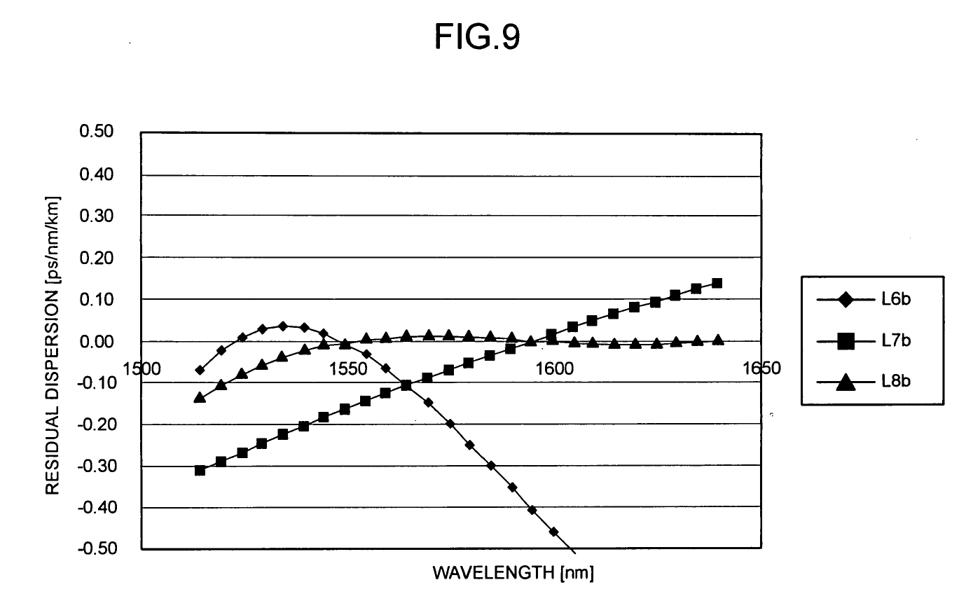

FIG. 9 is a graph of cumulative dispersion after a compensation for a dispersion in the transmission optical fiber 18 within the wavelength range from 1530 to 1625 nanometers, where each of the dispersion-compensating fiber 31 (curve L6b); the dispersion-compensating fiber 32 (curve L7b), and the dispersion-compensating module 30 (curve L8b) is individually linked to the transmission optical fiber 18.

The lengths of the dispersion-compensating fibers 31 and 32 are adjusted such that these dispersion-compensating fibers compensate for the cumulative dispersion in the transmission optical fiber 18 to become 0 ps/nm/km respectively at the wavelengths of 1550 nanometers and 1595 nanometers when each of the dispersion-compensating fibers 31 and 32 is independently linked to the transmission optical fiber 18. The length of the dispersion-compensating module 30 is adjusted such that the dispersion-compensating module 30 compensates for the cumulative dispersion in the transmission optical fiber 18 to become 0 ps/nm/km at the wavelength of 1550 nanometers.

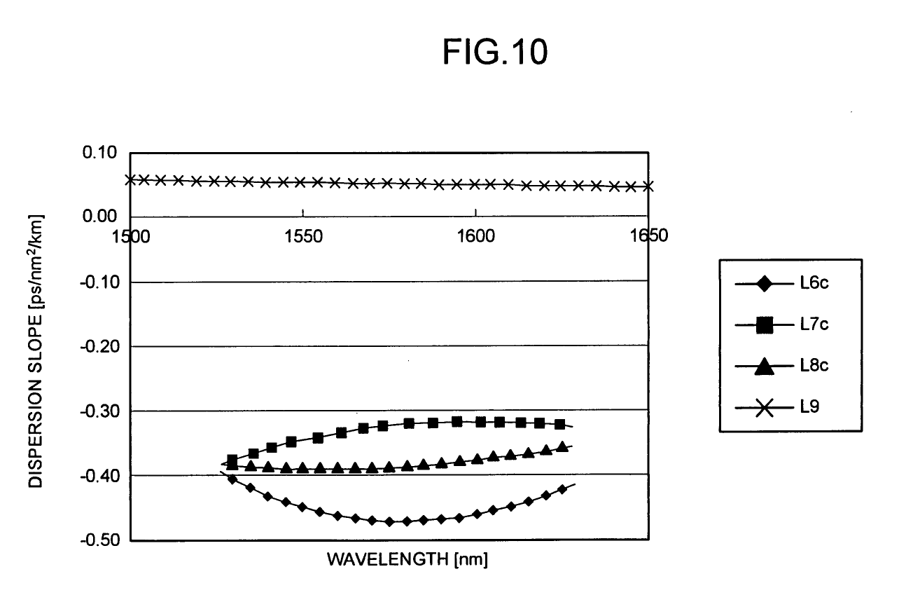

FIG. 10 is a graph showing dispersion slopes of the dispersion-compensating fiber 31 (curve L6c), the dispersion-compensating fiber 32 (curve L7c), the dispersion-compensating module 30 (curve L8c), and the transmission optical fiber 18 (curve L9) respectively.

When the signal light wavelength shifts to a longer wavelength in the wavelength range from 1530 to 1625 nanometers, the absolute value of the dispersion slope in the transmission optical fiber 18 tends to become smaller. Therefore, in order to apply the transmission optical fiber 18 as the high-speed WDM transmission line in the above-mentioned wavelength range, the absolute value of the dispersion slope in the dispersion-compensating module 30 needs to present a decreasing trend similar to that of the transmission optical fiber 18. In other words, it is preferable that an increase or decrease relationship of the dispersion slope in the dispersion-compensating module 30 relative to a change in the wavelength offsets an increase or decrease relationship of the dispersion slope in the transmission optical fiber 18.

As can be seen from FIG. 10, when the wavelength shifts to a longer wavelength in the wavelength range from 1530 to 1625 nanometers, the dispersion slope in the curve L9 is settled within the range from 0 to 0.1 ps/nm²/km, and linearly and mildly decreases. On the other hand, when the wavelength shifts from 1530 nanometers to a longer wavelength, the dispersion slope in the curve L6c gradually decreases, becomes minimum near the wavelength 1570 nanometers, and thereafter increases until the wavelength becomes 1625 nanometers (i.e., changes in convex to the downward direction towards the wavelength). When the wavelength shifts from 1530 nanometers to a longer wavelength, the dispersion slope in the curve L6c gradually decreases, becomes maximum near the wavelength 1580 nanometers, and thereafter decreases until the wavelength becomes 1625 nanometers (i.e., changes in convex to the upward direction towards the wavelength). In other words, the curve L6c and the curve L7c have a larger change in the dispersion slopes in the wavelength range from 1530 to 1625 than the curve L9. The curve shapes do not offset an increase or decrease change in the dispersion slope in the curve L9 relative to a change in the wavelength. Therefore, only any one of the dispersion-compensating fiber 31 and the dispersion-compensating fiber 32 cannot compensate for the dispersion slope cumulated in the transmission optical fiber 18 to enable the transmission optical fiber 18 to function as the high-speed WDM transmission line.

On the other hand, the dispersion slope in the curve L8c corresponds to the change in the dispersion slope in the dispersion-compensating module 30 that is realized based on the combination of the dispersion-compensating fibers 31 and 32, and has a curve shape that mutually offsets the curve L6c and the curve L7c. The dispersion slope in the curve L8c tends to mildly increase when the wavelength shifts to a longer wavelength in the wavelength range from 1530 to 1625 nanometers. In other words, the curve L8c has the equal change in the dispersion slope as the curve L9 in the wavelength range from 1530 to 1625 nanometers. The curve shape offsets an increase or decrease change in the dispersion slope in the curve L9 relative to a change in the wavelength. Therefore, the dispersion-compensating module 30 compensates for the dispersion slope cumulated in the transmission optical fiber 18 such that the absolute value of the cumulative dispersion in the transmission optical fiber 18 becomes equal to or less than 0.5 ps/nm/km. At the same time, the dispersion-compensating module 30 can compensate for the dispersion slope cumulated in the transmission optical fiber 18 such that the absolute value of the cumulative dispersion in the transmission optical fiber 18 becomes equal to or less than 0.01 ps/nm²/km and that the transmission optical fiber 18 can function as the high-speed WDM transmission line.

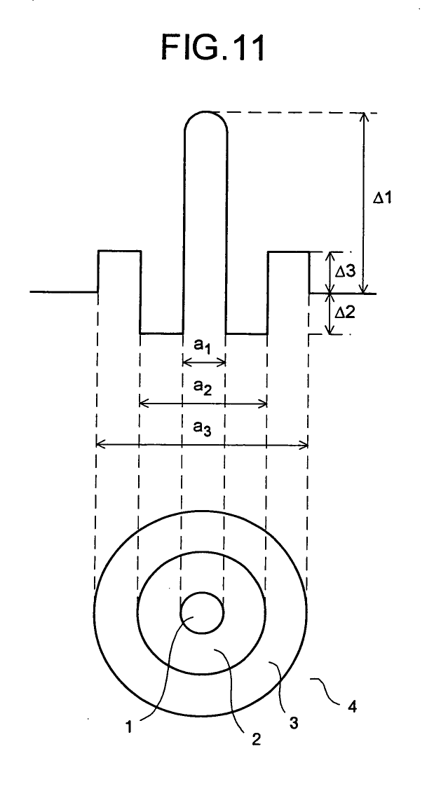

A detailed example of a refractive index profile that realizes the dispersion-compensating fibers 31 and 32 will be explained. The present invention is not limited to this example. FIG. 11 is a diagram of an exemplification of the refractive index profile that realizes the dispersion-compensating fibers 31 and 32 and a cross-sectional view of the dispersion-compensating fibers. As shown in FIG. 11, each of the dispersion-compensating fibers 31 and 32 include a core formed by three glass layers, and a cladding 4 that surrounds the core. This core is constituted in the order of a first core 1, a second core 2, and a third core 3 from the inside. The first core 1 has a diameter a₁, the second core 2 has a diameter a₂, and the third core 3 has a diameter a₃. In other words, the external diameter a₃ corresponds to the core diameters of the dispersion-compensating fibers 31 and 32. The first core 1 has a relative refractive index difference Δ1 with the cladding 4, the second core 2 has a relative refractive index difference Δ2 with the cladding 4, and the third core 3 has a relative refractive index difference Δ3 with the cladding 4.

Table 2 exemplifies in detail the refractive index profile that realizes the dispersion-compensating fibers 31 and 32. As shown in Table 2, the dispersion-compensating fiber 31 has the relative refractive index differences Δ1, Δ2, and Δ3 of 2.1, −0.6, and 0.24 respectively. A ratio of the diameter a₂ to the diameter a₁, i.e., a₂/a₁, is 2.42. A ratio of the diameter a₃ to the diameter a₂, i.e., a₃/a₂, is 1.96. When the diameter of the optical fiber is 125 micrometers, the core diameter a_{3 is} 14.4 micrometers. The dispersion-compensating fiber 32 has the relative refractive index differences Δ1, Δ2, and Δ3 of 2.1, −0.6, and 0.21 respectively. A ratio a₂/a₁, is 2.66, and a ratio a₃/a₂, is 1.96. When the diameter of the optical fiber is 125 micrometers, the core diameter a₃ is 15.0 micrometers.

TABLE 2

| | Δ1 | Δ2 | Δ3 | a₂/a₁ | a₃/a₂ | a₃ [μm] |
|---|---|---|---|---|---|---|
| Fiber 31 | 2.1 | −0.6 | 0.24 | 2.42 | 1.96 | 14.4 |
| Fiber 32 | 2.1 | −0.6 | 0.21 | 2.66 | 1.96 | 15.0 |

In this case, the dispersion-compensating fiber 31 has a dispersion slope that is a downwardly convex along a shift of the wavelength toward a longer wavelength as exemplified by the curve L6c shown in FIG. 10. The dispersion-compensating fiber 32 has a dispersion slope that is an upwardly convex along a shift of the wavelength toward a longer wavelength as exemplified by the curve L7c shown in FIG. 10. Therefore, when the dispersion-compensating fibers 31 and 32 having the refractive index profile as exemplified in FIG. 11 and Table 2 are used, the dispersion-compensating module 30 having the dispersion-compensating fiber 31 and the dispersion-compensating fiber 32 serially jointed together can make small the cumulative dispersion in the transmission optical fiber 18. At the same time, the dispersion-compensating module 30 can sufficiently compensate for the dispersion slope cumulated in the transmission optical fiber 18 that is used as the high-speed WDM transmission line.

The dispersion-compensating fiber 31 may have a downwardly convex change in the dispersion slope relative to a change in the wavelength. The change in the dispersion slope does not need to have a minimum value. For example, the dispersion slope of the dispersion-compensating fiber 31 may present a monotonous increase, with a gradual increase in the increase rate, along a shift of the wavelength toward a longer wavelength (i.e., a first monotonous increase). Alternatively, the dispersion slope of the dispersion-compensating fiber 31 may present a monotonous decrease, with a gradual decrease in the decrease rate, along a shift of the wavelength toward a longer wavelength (i.e., a first monotonous decrease). On the other hand, the dispersion-compensating fiber 32 may have a upwardly convex change in the dispersion slope relative to a change in the wavelength. The change in the dispersion slope does not need to have a maximum value. For example, the dispersion slope of the dispersion-compensating fiber 32 may present a monotonous increase, with a gradual decrease in the increase rate, along a shift of the wavelength toward a longer wavelength (i.e., a second monotonous increase). Alternatively, the dispersion slope of the dispersion-compensating fiber 32 may present a monotonous decrease, with a gradual increase in the decrease rate, along a shift of the wavelength toward a longer wavelength (i.e., a second monotonous decrease). In this case, it is preferable that the dispersion-compensating module 30 consists of the dispersion-compensating fiber 31 having the dispersion slope that presents the first monotonous increase, and the dispersion-compensating fiber 32 having the dispersion slope that presents the second monotonous increase. Alternatively, it is preferable that the dispersion-compensating module 30 consists of the dispersion-compensating fiber 31 having the dispersion slope that presents the first monotonous decrease, and the dispersion-compensating fiber 32 having the dispersion slope that presents the second monotonous decrease.

According to the second embodiment, the dispersion-compensating module 30 has the dispersion-compensating fiber 31 and the dispersion-compensating fiber 32 serially jointed by fusion-splicing at a predetermined length ratio, where the dispersion-compensating fiber 31 has a dispersion slope that presents a downwardly convex change relative to a change in the wavelength, and the dispersion-compensating fiber 32 has a dispersion slope that presents a upwardly convex change relative to a change in the wavelength. Therefore, when the transmission optical fiber that is used as the high-speed WDM transmission line is linked to the dispersion-compensating module 30, the dispersion-compensating module 30 can securely compensate for the dispersion slope in this transmission optical fiber. Further, as each dispersion value of the dispersion-compensating fibers 31 and 32 is set equal to or less than −100 ps/nm/km in the wavelength range from 1530 to 1625 nanometers, the dispersion value of the dispersion-compensating module 30 can always be set equal to or less than −100 ps/nm/km. With this arrangement, the cumulative dispersion in the transmission optical fiber after the compensation by the dispersion-compensating module 30 can be settled within the range from −0.3 to 0.3 ps/nm/km. As a result, it is possible to realize a dispersion-compensating module that can securely compensate for the cumulative dispersion and the dispersion slope in the high-speed WDM transmission line in a plurality of signal wavelength bands within the wavelength range from 1530 to 1625 nanometers.

In winding the dispersion-compensating fiber 31 and the dispersion-compensating fiber 32 around one bobbin 21, the dispersion-compensating fiber 32 having a relatively smaller bending loss in the maximum wavelength within a predetermined signal wavelength band is first wound around the bobbin 21. Therefore, the increase in the total bending loss in the dispersion-compensating module 30 can be suppressed. Further, the dispersion-compensating module that compensates for the high-speed WDM transmission line can be made more compact.

In the second embodiment, the dispersion-compensating module having a dispersion-compensating capacity that is optimum for the WDM transmission optical fiber having the C-band and the L-band as the signal wavelength bands is explained. However, the present invention is not limited to this. The present invention can also be applied to a dispersion-compensating module having a dispersion-compensating capacity that is optimum for adjacent two or more signal wavelength bands such as the WDM transmission optical fiber having the S-band and the C-band as the signal wavelength bands.

In the first and second embodiments, the dispersion-compensating module has two kinds of dispersion-compensating fibers serially jointed together, each dispersion-compensating fiber having a dispersion and a dispersion slope different from those of the other dispersion-compensating fiber. However, the present invention is not limited to this dispersion-compensating module. The present invention can also be applied to a dispersion-compensating module having three or more kinds of dispersion-compensating fibers serially jointed together, each dispersion-compensating fiber having a dispersion and a dispersion slope different from those of the other dispersion-compensating fibers.

Particularly, in the second embodiment, the two kinds of dispersion-compensating fibers are serially jointed together, each dispersion-compensating fiber having a dispersion and a dispersion slope different from those of the other dispersion-compensating fiber. However, each of the two dispersion-compensating fibers is not limited to have a single optical fiber, but may have a plurality of optical fibers serially jointed together.

In the first and second embodiments, dispersion-compensating fibers that constitute a dispersion-compensating module are directly jointed together by fusion-splicing. However, the present invention is not limited to this configuration. The present invention can also be applied to a dispersion-compensating module having dispersion-compensating fibers jointed together by fusion-splicing via a single mode fiber or a dispersion shifted fiber as an intermediate fiber. The present invention can also be applied to a dispersion-compensating module having dispersion-compensating fibers jointed together via a connector.

In the first and second embodiments, the dispersion-compensating module has a dispersion-compensating fiber and a transmission optical fiber jointed together via a connector. However, the present invention is not limited to this configuration. The present invention can also be applied to a dispersion-compensating module having a dispersion-compensating fiber and a transmission optical fiber linked together by fusion-splicing via a single mode fiber or a dispersion shifted fiber as an intermediate fiber. The present invention can also be applied to a dispersion-compensating module having a dispersion-compensating fiber and a transmission optical fiber directly linked together by fusion-splicing.

In the first and second embodiments, the dispersion-compensating module has a dispersion-compensating fiber configured by glass layers. However, the present invention is not limited to this configuration. The present invention can also be applied to a dispersion-compensating module having a dispersion-compensating fiber configured by plastic layers.

In the first and second embodiments, the dispersion-compensating module has dispersion-compensating fibers jointed together by fusion-splicing using an ultraviolet cured resin as a protection unit at the jointed portion. However, the present invention is not limited to this configuration. The present invention can also be applied to a dispersion-compensating module having dispersion-compensating fibers jointed together by fusion-splicing using thermally contractive tube or sleeve as a protection unit at the jointed portion.

### THIRD EMBODIMENT

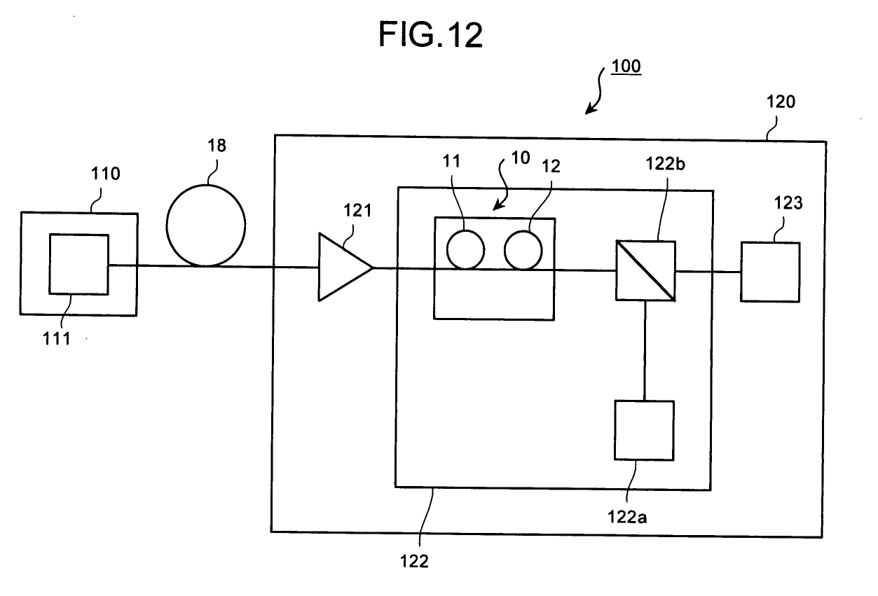

FIG. 12 is a block diagram of an optical transmission system according to a third embodiment of the present invention. A transmission optical fiber and a dispersion-compensating fiber that constitute an optical transmission system 100 are the same as those according to the first embodiment, and identical parts are attached with like reference numerals.

This optical transmission system 100 includes a transmission station 110 having a transmitter 111, and a reception station 120 having a receiver 123. The optical transmission system 100 also includes the transmission optical fiber 18 as a transmission line between the transmission station 111 and the reception station 120. The reception station 120 includes a Raman amplifier 121 and a dispersion-compensating system 122.

After a plurality of signal lights having a wavelength optionally selected from a wavelength range from 1460 to 1625 nanometers are combined together, the transmitter 111 transmits the combined signal light to the reception station 120. The transmitter 111 transmits the signal light to the reception station 120 via the transmission optical fiber 18.

The Raman amplifier 121 amplifies the signal light transmitted to the reception station 120. The Raman amplifier 121 has an excitation light source that generates a Raman scattering light, an amplification optical fiber, and an optical coupler. The Raman amplifier 121 amplifies the input signal light with a stimulated Raman scattering light. The signal light amplified by the Raman amplifier is transmitted to the dispersion-compensating system 122.

The dispersion-compensating system 122 has the dispersion-compensating module 10, an excitation light source 122a, and an optical coupler 122b. The dispersion-compensating module 10 compensates for the dispersion and the dispersion slope in the signal light transmitted to the dispersion-compensating system 122. Thereafter, the dispersion-compensating fibers 11 and 12 that function as Raman amplifiers, the excitation light source 122a, and the optical coupler 122b amplify this signal light.

After the dispersion-compensating system 122 compensates for the dispersion and amplifies the signal light, this signal light is transmitted to the receiver 123. The receiver 123 divides the signal light into signals by wavelengths, and receives these signals.

In the dispersion-compensating system 122, the dispersion-compensating module 20 or the dispersion-compensating module 30 according to the second embodiment may be used in place of the dispersion-compensating module 10.

The optical transmission system 100 transmits a signal light of a wavelength optionally selected from the wavelength range from 1460 to 1625 nanometers, via the transmission optical fiber 18. The dispersion-compensating module 10 optimized for the transmission optical fiber 18 compensates for the dispersion and the dispersion slope in this signal light. The dispersion-compensating fibers 11 and 12 that function as the Raman amplifiers amplify this signal light. Then, the receiver 123 receives this signal light. Therefore, it is possible to suppress the cumulative dispersion in the WDM transmission using the signal light of a wavelength optionally selected from the wavelength range from 1460 to 1625 nanometers over the S-band, the C-band, and the L-band. As a result, the optical transmission system suitable for high-speed WDM transmission can be realized.

When the dispersion-compensating module 10 in the dispersion-compensating system 122 is replaced by the dispersion-compensating module 20, a more compact optical transmission system can be realized without losing the above-mentioned operation effect.

Furthermore, when the dispersion-compensating module 10 in the dispersion-compensating system 122 is replaced by the dispersion-compensating module 20, the cumulative dispersion and the dispersion slope, which is in the high-speed WDM transmission line of a signal light in a plurality of signal wavelength bands optionally selected from the range of 1460 to 1625 nanometers, can be securely compensated for, and an optical transmission system suitable for a high-speed WDM transmission can be realized, without losing the above-mentioned operation effect.

As explained above, according to the dispersion-compensating module of the present invention, the jointing unit serially joints between the first dispersion-compensating fiber and the second dispersion-compensating fiber, the first dispersion-compensating fiber having a negative dispersion value and a negative dispersion slope, and the second dispersion-compensating fiber having a negative dispersion value and a negative dispersion slope different from the negative dispersion value and the negative dispersion slope that the first dispersion-compensating fiber has. In the optional signal wavelength band including at least 1530 to 1625 nanometers, the dispersion slope of the first dispersion-compensating fiber presents a upwardly convex change with a wavelength change, and the dispersion slope of the second dispersion-compensating fiber presents a downwardly convex change with a wavelength change. Therefore, the present invention has an effect that it is possible to securely compensate for a cumulative dispersion and a cumulative dispersion slope in the WDM transmission line. Further, a variance in the cumulative dispersion value in the transmission line after the dispersion compensation can be suppressed. Furthermore, a cumulative dispersion and a cumulative dispersion slope in the WDM transmission of an optional signal wavelength band including at least 1530 to 1625 nanometers can be securely compensated for.

Further, the optical transmission system according to the present invention has at least the dispersion-compensating module according to the present invention. Therefore, the effect of this dispersion-compensating module can be obtained. There is an effect that a high-speed WDM transmission can be securely realized.

Distinctive embodiments are described above to completely and clearly disclose the present invention. However, the appended claims are not limited to these embodiments. The claims must be configured to realize all modifications and replaceable configurations that those skilled in the art can create within a range of basic items disclosed in the present invention.

What is claimed is:

1. A dispersion-compensating module for compensating cumulative dispersion and dispersion slope of a transmission optical fiber in a predetermined signal wavelength band including at least 1530 to 1625 nanometers, comprising:
a first dispersion-compensating fiber having a negative first dispersion value and a negative first dispersion slope;
a second dispersion-compensating fiber having a negative second dispersion value and a negative second dispersion slope, the second dispersion value and the second dispersion slope being different from the first dispersion value and the dispersion slope respectively; and
a jointing unit that serially joints the first dispersion-compensating fiber with the second dispersion-compensating fiber, wherein
the first dispersion slope changes along an upwardly convex curve as the wavelength changes, and the second dispersion slope changes along a downwardly convex curve as the wavelength changes.

2. The dispersion-compensating module according to claim 1, wherein the first dispersion-compensating fiber and the second dispersion-compensating fiber are wound around a bobbin.

3. The dispersion-compensating module according to claim 2, wherein
a dispersion-compensating fiber having a smaller bending loss in a maximum wavelength of the predetermined signal wavelength band is first wound around the bobbin.

4. The dispersion-compensating module according to claim 1, wherein
the first dispersion compensation fiber and the second dispersion compensation fiber are jointed to each other by fusion.

5. The dispersion-compensating module according to claim 4, further comprising a protection unit around the jointing unit.

6. The dispersion-compensating module according to claim 5, wherein the protection unit includes ultraviolet cured resin.

7. The dispersion-compensating module according to claim 1, wherein
a dispersion value Dt [ps/nm/km] of the dispersion-compensating module at a center wavelength in the predetermined signal wavelength band satisfies an inequality of Dt≦−20.

8. The dispersion-compensating module according to claim 1, wherein
at the center wavelength in the predetermined signal wavelength band, a ratio of a dispersion value Dt [ps/nm/km] to a dispersion slope St [ps/nm²/km], that is, Dt/St, of the dispersion-compensating module and a ratio of a dispersion value D0 [ps/nm/km] to a dispersion slope S0 (ps/nm²/km], that is, D0/S0, of the transmission optical fiber satisfy an inequality of
0.9×(D0/S0)≦Dt/St≦1.1×(D0/S0).

9. The dispersion-compensating module according to claim 1, wherein
a ratio of the first dispersion value, D1, to the first dispersion slope, S1, and a ratio of a dispersion value D0 [ps/nm/km] to a dispersion slope S0 [ps/nm²/km] of the transmission optical fiber satisfy an inequality of
0.8×(D0/S0)≦D1/S1<D0/S0
and
a ratio of the second dispersion value, D2, to the second dispersion slope, S2, and the ratio D0/S0 satisfy an inequality of
D0/S0<D2/S2<1.2×(D0/S0).

10. The dispersion-compensating module according to claim 1, wherein
an absolute value of a cumulative dispersion value of the transmission optical fiber after a compensation by the dispersion-compensating module at the center wavelength in the predetermined signal wavelength band is equal to or less than 0.5 ps/nm/km, and an absolute value of a cumulative dispersion slope of the transmission optical fiber is equal to or less than 0.01 ps/nm²/km.

11. The dispersion-compensating module according to claim 1, wherein
an absolute value of a cumulative dispersion value of the transmission optical fiber after a compensation by the dispersion-compensating module in the predetermined signal wavelength band is equal to or less than 0.5 ps/nm/km, and an absolute value of a cumulative dispersion slope of the transmission optical fiber equal to or less than 0.01 ps/nm²/km.

12. The dispersion-compensating module according to claim 1, wherein
at least one of the first dispersion-compensating fiber and the second dispersion-compensating fiber has a function to be equipped with Raman amplifier.

13. An optical transmission system comprising at least the dispersion compensation module according to claim 1.
